(19) United States
(12) Patent Application Publication
(10) Pub. No.: US 2012/0018647 A1
(43) Pub. Date: Jan. 26, 2012

(54) DETECTION METHOD FOR TECHNETIUM 99

(76) Inventors: Celestino Abrego, Springfield, VA (US); David Nichols, Duncan, OK (US)

(21) Appl. No.: 12/908,645

(22) Filed: Oct. 20, 2010

Related U.S. Application Data
(60) Provisional application No. 61/366,680, filed on Jul. 22, 2010.

(51) Int. Cl. G01N 23/22

(52) U.S. Cl. 250/370.12; 250/393

(57) ABSTRACT

A method of determining the presence of ⁹⁹Tc in a container includes the steps of (a) subjecting the exterior of the container to neutron bombardment of sufficient energy to assure passage of the neutrons to the interior of the container; and (b) observing the emission or non-emission of gamma radiation from the container at energy levels of about 540 keV and about 591 keV as an indicator of the presence or non-presence, respectively, of ⁹⁹Tc within the container.

### CROSS-REFERENCE TO RELATED APPLICATIONS

This application claims priority from Provisional Patent Application Ser. No. 61/366,680, filed Jul. 22, 2010, entitled METHOD OF DETERMINING THE PRESENCE OF ⁹⁹Tc WITHIN A SEALED CONTAINER, and which is incorporated herein in its entirety.

### FIELD OF THE INVENTION

This invention relates generally to methods of detecting radioactive contamination and, more specifically, to detecting the presence of radioactive technetium 99 (⁹⁹Tc).

### BACKGROUND

The Department of Energy has a large collection of waste-containing steel containers in need of disposal that may or may not be contaminated with ⁹⁹Tc. Since there are no known reliable methods for detecting ⁹⁹Tc within sealed steel containers, either each container must be opened (a very unsafe procedure) to test for the presence of ⁹⁹Tc, or all of the containers must be disposed of in radioactive waste disposal sites.

⁹⁹Tc is a radioactive isotope, with a half life of 210,000 years. When it decays (to ⁹⁹Ru, which is stable), it decays by beta emission (at about 290 keV). The beta particle is an electron, which is readily absorbed by any surrounding steel and can be difficult to detect. Very infrequently (less than 5×10⁻⁶% of the time), the ⁹⁹Tc will emit a gamma ray at about 90 keV, which is similarly easily absorbed and difficult to detect. Thus, determining the presence (or absence) of ⁹⁹Tc by passive radiation detection is difficult, if not impossible, for small quantities.

Thus, there is a need for a method by which the presence of ⁹⁹Tc within sealed steel containers can be reliably detected.

### SUMMARY

The invention satisfies this need. The invention is a method of determining the presence of ⁹⁹Tc within a container, such as a sealed container which effectively absorbs gamma radiation emitted by the decay of ⁹⁹Tc to ⁹⁹Ru. The method comprises the steps of (a) subjecting the exterior of the container to neutron bombardment of sufficient energy to assure passage of the neutrons to the interior of the container; and (b) observing the emission or non-emission of gamma radiation from the container at energy levels of about 540 keV and about 591 keV as an indicator of the presence or non-presence, respectively, of ⁹⁹Tc within the container.

### DRAWINGS

These and other features, aspects and advantages of the present invention will become better understood with reference to the following description, appended claims and accompanying drawings where:

FIG. 1 is a diagrammatic depiction of an apparatus useful in practicing the invention;

FIG. 2 is a graphic representation of the results of a hypothetical example of the application of one embodiment of the invention; and

FIG. 3 is graph illustrating a radiation spectrum detected in the hypothetical example of FIG. 2.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The inventors have noted that ⁹⁹Tc has a modestly large cross section for absorption of thermal neutrons, at 23 barns. (1 barn=10⁻²⁴ cm², and represents the likelihood of an interaction occurring.) In the intermediate energy range—such as about 400 barns—the cross section is even larger. When a ⁹⁹Tc atom absorbs a neutron, it becomes a ¹⁰⁰Tc atom. ¹⁰⁰Tc has a half life of 16 seconds, and emits high-energy penetrating gamma rays at 540 keV and 591 keV, about 6% of the time. Such high-energy gamma rays readily penetrate and pass through steel. The 540 keV and 541 keV gamma rays are readily distinguishable from other radionuclides that may be present. Because the half life is short, the ¹⁰⁰Tc decay gamma rays are generated relatively quickly.

Accordingly, the inventors have reasoned that a method by which the presence of ⁹⁹Tc can be detected within a container, such as a sealed container, which effectively absorbs low-energy gamma radiation) can be accomplished by the steps of (a) subjecting the exterior of the sealed container to neutron bombardment of sufficient energy to assure passage of the neutrons to the interior of the container; and (b) observing the emission or non-emission of gamma radiation from the container at energy levels of about 540 keV and about 591 keV as an indicator of the presence or non-presence, respectively, of ⁹⁹Tc within the container.

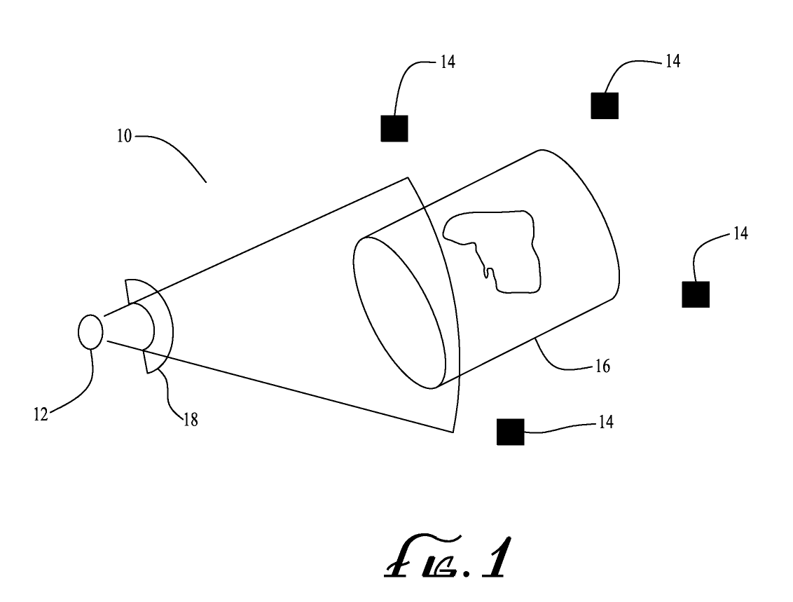

FIG. 1 illustrates a typical apparatus 10 for carrying out the invention. The apparatus includes a neutron source 12, spectroscopic gamma detectors 14 and a container 16 (typically made of carbon steel) potentially contaminated with ⁹⁹Tc.

The neutron source is used to transmute the ⁹⁹Tc into ¹⁰⁰Tc. Neutron sources (typically a mix of americum and beryllium, plutonium and beryllium, or radium and beryllium) can be commercially obtained up to about 10⁸ neutrons per second. However, sources with this level of activity usually require special licenses and special handling procedures to minimize exposure. Neutron generators are also commercially available to generate significantly higher neutron fluxes.

The neutrons generated from commercially available neutron sources are typically of high energy (around 2 MeV) and need to be slowed down or moderated to a level that is most efficient for transmuting the ⁹⁹Tc into ¹⁰⁰Tc. Modeling and simulation methods commonly known in the art are used to determine the most effective amount of moderator for each application. In the apparatus illustrated in FIG. 1, a neutron moderator is shown as element 18. Neutron moderators comprising sheets of polyethylene, ranging from 0.5 inch to 2 inches in thickness, can be inserted, for example, between the source and the target to act as an efficient neutron moderator. Alternatively, other hydrogenous materials can be used, depending upon the application and typically determined from modeling and simulation calculations.

Once the desired energy level of the neutrons is determined, a dwell time is selected. The dwell time is that period of time wherein the instrument is allowed to sit and cook while signal builds up. Dwell time is a balance of the ¹⁰⁰Tc production rate and the ¹⁰⁰Tc loss rate. The ¹⁰⁰Tc production rate is how many ⁹⁹Tc atoms are converted into ¹⁰⁰Tc atoms per unit of time. The ¹⁰⁰Tc loss rate is how many ¹⁰⁰Tc atoms decay into ¹⁰⁰Ru atoms per unit of time—because of the 16-second half life of ¹⁰⁰Tc. The number of ¹⁰⁰Tc atoms existing within the container approaches an upper limit asymptotically. Such upper limit is approached after 5-6 half-lives of the ¹⁰⁰Tc, or about 80-96 seconds.

As noted above, a spectroscopic gamma detector is used to detect the 540 and 591 keV gamma rays. At least two different types of spectroscopic gamma detectors can be used in the invention: a spectroscopic gamma detector which employs high purity germanium (HPGe) and a spectroscopic gamma detector which employs sodium iodide (NaI).

A HPGe spectroscopic gamma detector yields excellent 0.3% energy resolution. The spectroscopic lines are clear, sharp, and unambiguous. However, HPGe spectroscopic gamma detectors are expensive, must be cryogenically cooled, and the largest cylindrical crystals commercially available are about 3.2×3.2 inches, which is a relatively small collection area. Preferably, however, an HPGe spectroscopic gamma detector is employed at least in any prototype system, to ensure that any complicating gamma rays from nitrogen or oxygen can be clearly delineated from the ¹⁰⁰Tc gamma rays.

A NaI spectroscopic gamma detector is relatively inexpensive, rugged, and readily adaptable to a spectroscopic gamma detector having a large log of up to 4×4×16 inches. The energy resolution of a NaI spectroscopic gamma detector is around 8%, which means that individual peaks are more smeared than they are with HPGe spectroscopic gamma detectors. However, once the proof of principle has been demonstrated with an HPGe spectroscopic gamma detector in a particular application, it is likely that the better energy resolution of an HPGe spectroscopic gamma detector will be outweighed by the larger collection area of a NaI spectroscopic gamma detector (which allows a better signal detection) and is the more affordable.

Commercial-grade software is readily available (e.g., GADRAS; Maestro; Genie) to deconvolve the energy spectra determined in the spectroscopic gamma detectors, and to thereby determine the presence or absence of ¹⁰⁰Tc.

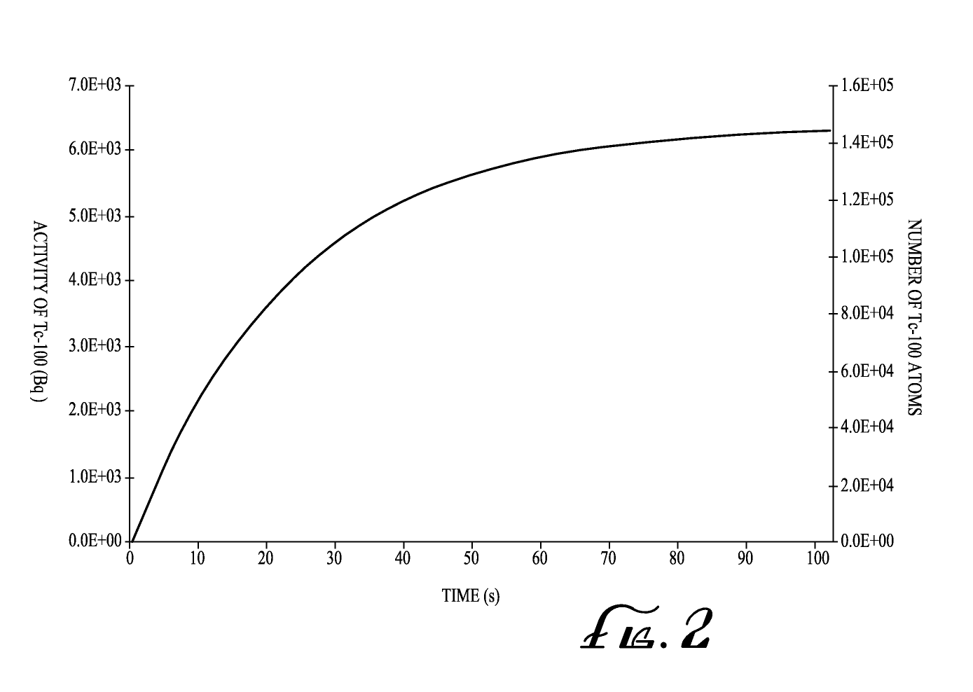

FIG. 2 represents the results which would be expected in a hypothetical example wherein 1 mg of ⁹⁹Tc is contained in a 1 cc volume, and the sample is irradiated. In this hypothetical example, the effective flux is assumed to be 6×10⁷ n/cm²-s (6 mg of Cf-252), the cross section is assumed to be 17.49 b, the number of Tc atoms is 6×10¹⁵ atoms/cc, and the mass of ⁹⁹Tc present is 10 mg. FIG. 2 illustrates the fact that the signal will not become significantly stronger by having the neutron source stay in one location for longer than about a minute.

In this hypothetical example, it is assumed that the presence of 1 milligram of ⁹⁹Tc generates an activity level of 6000 Bq. Activity is assumed to follow the equation:

A(t)=A_{∞}(1−e^{-λt})

where A is activity, t is time, and λ is the decay constant for ¹⁰⁰Tc.

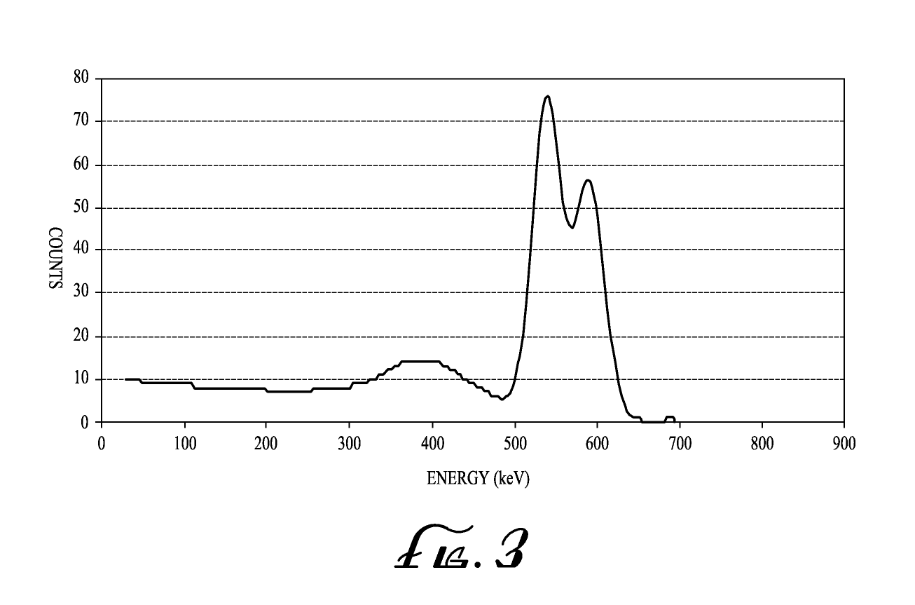

FIG. 3 illustrates the resultant radiation spectrum which would be expected using a 4″×4″ NaI detectors. As can be understood from FIG. 3, the ¹⁰⁰Tc peaks are clearly defined in the expected region of interest (540 and 590 keV). The spectrum is the expected result under the conditions of the hypothetical example, and would be measured immediately after the container is sufficiently exposed to neutrons. In the hypothetical example, the container would be deemed contaminated and quarantined for further examination. The results illustrated in FIG. 3 indicate that the method will likely detect ⁹⁹Tc to a milligram level.

The method provides a way to detect the presence of approximately milligram-levels of ⁹⁹Tc, without opening up the container. This allows for safe and convenient disposal of those containers that are not contaminated with ⁹⁹Tc.

Having thus described the invention, it should be apparent that numerous structural modifications and adaptations may be resorted to without departing from the scope and fair meaning of the instant invention as set forth hereinabove.

What is claimed is:

1. A method of determining the presence of ⁹⁹Tc within a container having an exterior and an interior, the container being capable of effectively absorbing gamma radiation emitted by ⁹⁹Tc decay to ⁹⁹Ru, the method comprising the steps of:
(a) subjecting the exterior of the container to neutron bombardment of sufficient energy to assure passage of the neutrons to the interior of the container; and
(b) observing the emission or non-emission of gamma radiation from the container at energy levels of about 540 keV and about 591 keV as an indicator of the presence or non-presence, respectively, of ⁹⁹Tc within the container.

2. The method of claim 1 wherein the container is a sealed container.

3. The method of claim 1 wherein the container is made of steel.

4. The method of claim 1 wherein the step of subjecting the exterior of the container to neutron bombardment employs neutrons generated from a neutron source having an energy level moderated to less than 2 MeV.

5. The method of claim 2 wherein the neutrons from the electron source are moderated using sheets of polyethylene ranging from 0.5 inches to 2 inches in thickness.

6. The method of claim 1 wherein the step of observing the emission or non-emission of gamma radiation from the container is accomplished with an HPGe spectroscopic gamma detector.

7. The method of claim 1 wherein the step of observing the emission or non-emission of gamma radiation from the container is accomplished with an NaI spectroscopic gamma detector.
